(19) United States
(12) Patent Application Publication
(10) Pub. No.: US 2005/0069686 A1
(43) Pub. Date: Mar. 31, 2005

(54) Composition comprising a substrate and image affixed thereto, process of preparation thereof, and assemblage of reaction products

(76) Inventor: Pennie Ann Hoops, Paso Robles, CA (US)

Correspondence Address: ROBERT E. HARTENBERGER, 2867 TOWNSHIP ROAD, PASO ROBLES, CA, 93446, US

(21) Appl. No.: 10/670,295

(22) Filed: Sep. 26, 2003

(51) Int. Cl. B32B 27/30; B05D 3/02; B05D 1/36

(52) U.S. Cl. 428/201; 428/522; 427/385.5; 427/407.1

(57) ABSTRACT

A composition comprising a substrate, an intermediate layer adhered to the substrate, said intermediate layer being capable of receiving a graphic image, and a protective sealant covering the intermediate layer. Also, a method for producing the composition comprising adhering to the substrate an intermediate layer optionally having a graphic image present on the intermediate layer, and covering the intermediate layer and the optional image with a protective sealant. Also, a collection of the component starting materials for producing the composition.

### BACKGROUND OF THE INVENTION

This invention relates to a composition comprising a substrate, an adhesive positioned on the surface of said substrate, an adhesive-impermeable intermediate layer having a first surface in contact with said adhesive, and a second surface containing ink adhered to said second surface, and a protective sealant applied to the ink-adhered second surface.

Images used for identification, jewelry, and other forms of decoration have been prepared in a variety of shapes and configurations for millennia. As technology has advanced, so also have methods for fabricating the images, and the images themselves.

Processes for coating and protecting metal and other durable surfaces are known in the art. Automobiles, bicycles, and other vehicles have been coated with a variety of decorative materials and subsequently coated with a protective layer to preserve the decorative characteristics of the first coating. Identification badges have been imprinted with a person's name or organizational affiliation, and then coated with a protective layer of clear polymeric material to enhance and protect the surface of the badge or emblem.

Some of the above coatings use materials which can become toxic or otherwise hazardous under the conditions of application. Many of the coatings and methods of application use expensive application equipment which is useful only in the application of relatively huge amounts of protective coatings.

Critical to the success of my product and method is a strong adhesion between the intermediate layer and the sealant, which adhesion and contact does not alter, smear, or distort the ink and the image it forms. None of the above prior art techniques and products produced from those techniques are capable of avoiding the above disadvantages of the prior art.

### SUMMARY OF THE INVENTION

It is a principal object of this invention to provide a product having an ink image affixed to a substrate and a protective sealant covering the image and protecting it from wear and defacement.

It is another principal object of this invention to provide a decorative object having an image affixed to a substrate and a protective sealant covering the image and protecting it from wear and defacement.

It is a further object of this invention to provide a decorative object in which the decoration is created in part by an ink image applied to an intermediate layer of material positioned between the substrate and protective sealant.

It is a further object of this invention to provide a method for producing the aforementioned object using an intermediate layer of material containing an image, which intermediate layer is positioned between a substrate and a protective sealant.

It is a further object of this invention to produce an element of jewelry having a photographic image placed on said element.

The present invention comprises a product having a substrate, said substrate having a work surface, a cured bonding agent positioned on said work surface, an intermediate layer of material having a first surface and a second surface, said first surface in contact with said cured bonding agent and said second surface having an image positioned thereon and not in contact with said bonding agent, and a protective sealant placed over said second surface having said image positioned thereon.

The invention further relates to a method for producing a product comprising a substrate having an image placed thereon comprising:
a) applying a bonding agent to the interface between the work surface of a substrate and a first surface of an intermediate layer,
b) applying an image to a second surface of said intermediate layer,
c) applying to said work surface the first surface of said intermediate layer of material,
d) curing said bonding agent to a stage which causes adhesion between said work surface and said first surface of the intermediate layer,
e) applying a protective sealant over said second surface of the intermediate layer and said image applied thereto, and
f) curing said protective sealant.

The present invention also relates to a collection of components suitable for assembly into the products of this invention comprising a substrate having a work surface, a bonding agent capable of bonding said substrate to an intermediate layer, an intermediate layer having a first surface which is impermeable to said bonding agent and a second surface which is receptive to ink and paint images, and a protective sealant which is capable of protecting the intermediate layer and the ink image placed thereon.

### BRIEF DESCRIPTION OF THE DRAWINGS

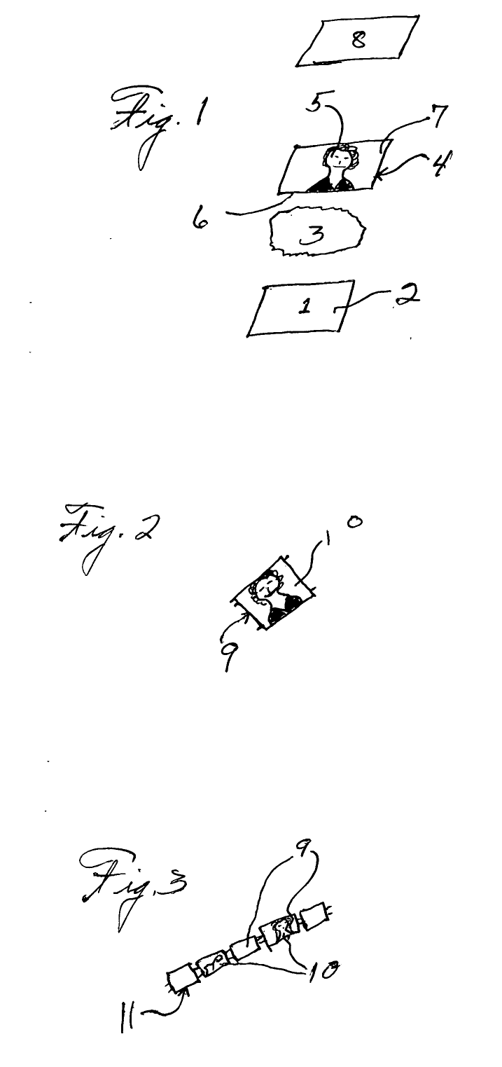

Advantages of one or more features of the present invention will be understood by reference to the following detailed description when considered in conjunction with the accompanying drawing in which FIG. 1 is a pictorial, segmented perspective view of the essential components of the invention. FIG. 2 is a perspective view of a jewelry bracelet showing one of the decorative products of this invention with a pictorial image on a segment of the bracelet. FIG. 3 shows a series of segments linked together to form a portion of a bracelet.

### DETAILED DESCRIPTION OF THE INVENTION

The compositions of the present invention comprise a substrate having a work surface capable of receiving a bonding agent which will adhere to said work surface. The numbers of materials which can function as a substrate are almost limitless. Suitable substrates are limited principally by the end use of the assembled composition. One preferred substrate is made of a metal such as stainless steel, silver, gold, and the like because of their suitability for use in jewelry such as bracelets, pins, necklaces and the like. Other acceptable substrates can be manufactured from plastics such as (poly)methyl methacrylate and epoxy resins, and from glass and wood. Any surface capable of being bonded with the bonding agents of this invention can be used to produce the compositions of this invention. The work surface of the substrate refers to that segment of the substrate to which the bonding agent is applied before the intermediate layer is placed on the work surface. The work surface can be planar or any curvilinear surface which permits the intermediate layer to conform to the surface satisfactorily. One preferred work surface is a planar surface having a finish permitting the bonding agent to adhere to the surface satisfactorily.

The bonding agent can be selected from a wide variety of glues and adhesive products. A preferred bonding agent is a composition comprising an alkyl cyanoacrylate and a (poly)methyl methacrylate. Other suitable bonding agents include a large number of epoxy resins having variable curing times. The choice of suitable bonding agents can vary, depending upon the materials used as the substrate and as the intermediate layer. For example, if the substrate is wood, the choice of bonding agent may be different from that chosen if the substrate is metal. Several commercial adhesives are available and can be selected for use with a minimum of evaluation. If for instance the substrate is paper or wood, and the intermediate layer is also paper or plastic sheet, a commercially available adhesive is 77 Spray Adhesive from 3M Industrial Specialties. Other examples of suitable bonding agents include IBD Brush On Nail Glue, 5 Second Glue, and European Secrets Lightning brand adhesive.

The intermediate layer can be selected from a large number of substances in a variety of shapes. Paper, wood, polymeric materials, and metal are examples of some preferred substances. Any substance which can be modified by applying an image to a surface of the intermediate layer is included herein if it has the requisite two surfaces. The layer can have more than two surfaces, but requires that at least two surfaces be present and in contact with the other components in the manner described herein. If the finished composition is intended to have an ink or paint image on the intermediate layer which is affixed to the substrate, it is advisable that the layer have a surface capable of receiving and retaining the image in an intact manner under the conditions of manufacture used herein. When photographic or artistic images are printed upon the intermediate layer, a preferred type of intermediate layer is printing paper for photographic images. Commercially available papers include Kodak photographic papers, as well as papers marketed under the Avery and Staples brand names. Although the preferred photographic papers are among the aforementioned commercial products, all papers which can be imprinted with ink or toner from a printer are included within the scope of this invention.

There are a wide variety of printers and printing inks and toners. This invention encompasses all inks, toners and other materials which can be applied to the photographic paper or other intermediate layer.

The photographic paper can contain components other than paper in the traditional sense. Metal or plastic sheeting such as Mylar films can be used to produce a foil-containing photographic sheet which is capable of producing desirable effects in the practice of this invention.

The intermediate layer need not be modified by ink or paint as mentioned above, but if it is so modified, the ink or paint can be any material used to produce images on a surface and is not limited to the traditional materials identified as ink and paint. For example, the material applied by inkjet and laser jet office printers is one preferred type of ink useful herein. Other inks and paints can be oil-based or acrylic-based inks and paints.

The protective sealant can be any substance capable of protecting the intermediate layer from water, heat, cleaning agents and any other number of substances which could destroy or alter the appearance of the intermediate layer or the image placed thereon. Clear acrylic polymers are one example of a suitable protective sealant. Polycarbonate resins are another polymeric material which can be used herein. Other sealants can be readily selected by those skilled in the art. Chemically and environmentally resistant resins having good clarity, resistance to scratching and abrasion, and capability of being easily cured are preferred protective sealants. One suitable protective sealant is a composition produced from a commercially available sealing agent containing acrylate oligomer and methacrylate ester monomers, available from American International Industries European Secrets.

The curing of the aforementioned protective sealants can be accomplished by following the instructions supplied with the protective sealants. Curing times for the protective sealants can be adjusted by controlling temperature, as well as by the use of accelerants and catalysts.

The present invention includes not only the above described compositions in finished form but also the collection of starting materials used to produce the finished composition. The collection comprises a substrate having a work surface capable of receiving a bonding agent which will adhere to said work surface, an uncured bonding agent capable of bonding said substrate to an intermediate layer, an intermediate layer of material having a first surface which is impermeable to said bonding agent and a second surface which is receptive to ink and paint images, and an uncured material capable of forming a protective sealant following application to the intermediate layer of material.

The present invention also comprises the method for producing a substrate having an image placed thereon. To the work surface of the substrate a bonding agent is applied. Depending on the equipment used to assemble the components of the invention, it may be desirable to have a bonding agent with a curing time which is adjustable to permit the fabrication of one or more finished products simultaneously or sequentially. Specifically, if the assembly equipment has eight or more assembly stations, a cure time for the bonding agent could be two minutes or longer to give the operator sufficient time to position the several substrates and intermediate layers with respect to each other. If a product is assembled sequentially, one at a time, the cure time for the bonding agent could be ten seconds or less, up to several hours.

The bonding agent can be applied manually or in automated fashion. The amount of bonding agent can vary, depending upon the nature of the work surface and the porosity or impermeability of the intermediate layer. Most desirably, it is advisable that the quantity of bonding agent be sufficient to cover the entire area of the first surface of the intermediate layer, but not so much that bonding agent is expressed out beyond the perimeter of the intermediate layer. The bonding agent can be applied either to the work surface of the substrate or to the first surface of the intermediate layer. It is advisable to use a quantity of bonding agent which will not be expressed beyond the perimeter of the intermediate layer.

Although the bonding agent need not be completely cured prior to the application of the protective sealant to the second surface of the intermediate layer, it is preferred that the bonding agent be at least sufficiently cured to hold the intermediate layer in a position fixed and immovable with respect to the work surface of the substrate.

The image which is placed on the intermediate layer can be so placed at any of several stages in the practice of this invention. Preferably, the image is placed on the intermediate layer prior to placing bonding agent on the first surface of the intermediate layer, or on the work surface of the substrate. The image can be placed on the intermediate layer by the application of ink, paint or by positioning a three dimensional figure on the second surface of the intermediate layer. One satisfactory technique has been to place an ink image on the intermediate layer applied through the use of a computer printer. If the image is in the form of letters or text, the image can be created by any satisfactory word processing program. If the image is in the form of a photograph, there are similar software programs that can be used to print the photograph on the intermediate layer. Artistic images can be created with other software programs which can be used to print the artistic images on the intermediate layer. Examples of software packages capable of editing photographic images include Adobe Photo Shop, Quark Express, Microsoft Publisher, Microsoft Picture It, and Greeting Card Workshop.

After the complete or partial curing of the bonding agent, the protective sealant is applied to the second surface of the intermediate layer, and the protective sealant is cured to form a layer protecting the intermediate layer and the image applied to the layer. It is preferred that the uncured sealant be applied over the entire perimeter of the intermediate layer so that upon curing the intermediate layer is completely covered by the cured protective sealant. Even more preferably, if the work surface of the substrate has a perimeter which extends beyond the perimeter of the intermediate layer, the protective sealant can be applied so that it extends beyond the perimeter of the intermediate layer but within the outside perimeter of the work surface of the substrate.

Conditions of curing the protective sealant will vary depending upon the particular sealant chosen for use in the instant process. Conditions for curing sealants are described on the containers of commercially available sealants, or in the case of non-commercial sealants will be readily known to those skilled in the art. Ultraviolet radiation from a low wattage lamp such as a 9 watt lamp has worked satisfactorily with many of the protective sealants useful herein.

Referring to the Figures accompanying this document, FIG. 1 is a segmented perspective view of one embodiment of this invention. Substrate 1 has a work surface 2 which is positioned to receive bonding agent 3, which when applied to work surface 2 has linear dimensions approximately coextensive with the perimeter of work surface 2. Intermediate layer 4 has an image 5 positioned on second surface 7 of intermediate layer 4. First surface 6 (not visible) is on the underside of intermediate layer 4. Protective coating 8 is positioned over second surface of intermediate layer 4. FIG. 2 shows an assembled element 9 with an image 10 present on assembled element 9. FIG. 3 shows a portion of an expansion band 11 in which band 11 contains a plurality of assembled elements 9 with images 10 positioned on assembled elements 9.

The invention will be more fully understood by reference to the following specific examples.

### EXAMPLE 1

A digital reproduction of a photographic image is formed using a commercially available software package capable of sizing, cropping and otherwise editing the photographic image. The digitally produced image is then printed onto a commercially available photographic paper using the aforementioned software package to reproduce the desired enhanced photographic image in a size and shape which will fit properly onto a stainless steel metal substrate. The enhanced image is produced in color using a commercially available color inkjet printer to print the enhanced image, which has the linear dimensions of 8 by 4 mm. The enhanced image is printed onto a commercially available photographic paper using a color inkjet printer. The enhanced image is attached to the stainless steel substrate using a bonding agent comprising an alkyl cyanoacrylate and a polymethyl methacrylate. The bonding agent is allowed to cure for eight hours.

To the surface of the enhanced photographic image, a transparent protective coating is applied to protect the surface of the enhanced image. The coating comprises a mixture of acrylate oligomers and methacrylate ester monomers. The liquid mixture is applied to the upper surface of the enhanced image and permitted to stand for fifteen minutes to permit entrapped gases to escape. The above composition is placed in a 9 watt low pressure UV lamp in an ultraviolet oven for about three hours to produce a final cured protective coating of the enhanced photographic image adhered to the metal substrate.

### EXAMPLE 2

The procedure of Example 1 is followed except that a thinner commercially available photographic paper is used, the bonding agent is allowed to cure for 1.5 hours, and the protective coating is cured in a UV oven using a 9 watt low pressure UV lamp for about 3 hours.

### EXAMPLE 3

The procedure of Example 1 is followed except that a different commercially available photographic paper is used, the bonding agent is allowed to cure for 1.5 hours, and the protective coating is cured in an UV oven using a 9 watt low pressure UV lamp for about 1.5 hours.

### EXAMPLE 4

The procedure of Example 3 is followed except that the photographic paper is a different brand and the paper has a matte finish.

1. A product comprising a substrate, said substrate having a work surface, a cured bonding agent positioned on and adhesively adhered to said work surface, an intermediate layer having a first surface and a second surface, said first surface in adhesive contact with said cured bonding agent and said second surface having an image positioned thereon and not in contact with said bonding agent, and a protective sealant adhesively positioned over said second surface having said image positioned thereon.

2. A product according to claim 1 wherein said cured bonding agent is the reaction product of an alkyl cyanoacrylate and a (poly)methyl methacrylate.

3. A product according to claim 1 wherein said intermediate layer is paper for printing photographic images.

4. A product according to claim 1 wherein said image is formed from a printing ink.

5. A product according to claim 1 wherein said protective sealant is the reaction product of an acrylate oligomer and methactrylate ester monomers.

6. A product according to claim 1 wherein said protective sealant includes a photoinitiator for curing said sealant.

7. A method for producing a substrate having an image placed thereon comprising:
a) applying a bonding agent to the interface between the work surface of a substrate and a first surface of an intermediate layer,
b) applying an image to a second surface of said intermediate layer,
c) applying to said work surface the first surface of said intermediate layer of material,
d) curing said bonding agent to a stage which causes adhesion between said work surface and said first surface of the intermediate layer,
e) applying a protective sealant over said second surface of the intermediate layer and said image applied thereto, and
f) curing said protective sealant.

8. A method according to claim 7 wherein said bonding agent is applied to the work surface of the substrate prior to placing the intermediate layer in contact with said work surface.

9. A method according to claim 7 wherein said bonding agent is cured prior to placing the protective sealant over said second surface of the intermediate layer.

10. A method according to claim 7 wherein said protective sealant contains a photoinitiator for curing said sealant with ultraviolet radiation.

11. A method according to claim 10 wherein said protective sealant is cured with ultraviolet radiation.

12. A collection of components comprising a substrate having a work surface, a bonding agent capable of bonding said substrate to an intermediate layer, an intermediate layer having a first surface impermeable to said bonding agent and a second surface which is receptive to ink and paint images, and a protective sealant capable of protecting the intermediate layer and the ink image placed thereon.

13. A collection according to claim 12 wherein said bonding agent comprises an alkyl cyanoacrylate and a polymethyl methacrylate.

14. A collection according to claim 12 wherein said protective sealant comprises acrylate oligomers and methacrylate ester monomers.

15. A collection according to claim 12 wherein said intermediate layer is photographic paper.

16. A collection according to claim 15 wherein said photographic paper has a foil layer.
